(19) United States
(12) Patent Application Publication
(10) Pub. No.: US 2004/0200076 A1
(43) Pub. Date: Oct. 14, 2004

(54) Themed eating utensils

(76) Inventors: Christina M. Tranfaglia, Glenview, IL (US); Jeffrey L. Roberts, Round Lake Park, IL (US); Mitchell A. Lopata, Skokie, IL (US); David E. Barnard, St. Paul, MN (US); Richard A. Nelipovich, Madison, WI (US); Cory R. Boudreau, Madison, WI (US); Ami M. Verhalen, Sun Prarie, WI (US)

Correspondence Address: JENKENS & GILCHRIST, P.C., 225 WEST WASHINGTON, SUITE 2600, CHICAGO, IL, 60606, US

(21) Appl. No.: 10/411,633

(22) Filed: Apr. 11, 2003

(51) Int. Cl. A47J 43/28

(52) U.S. Cl. 30/322

(57) ABSTRACT

Eating utensils are provided which incorporate animal themes using depictions of animal features as eating utensil elements. A variety of depictions of animal features may be incorporated into a variety of utensils and utensil elements. Knives, forks, spoons, and spreaders are provided according to some embodiments, with respective utensil elements corresponding to individual animal features. Several types of utensils may be packaged together, with a variety of animal feature depictions corresponding to different utensil elements.

### FIELD OF THE INVENTION

The present invention generally relates to eating utensils and more particularly relates to the arrangement and manufacture of eating utensils having themes.

### BACKGROUND OF THE INVENTION

Eating utensils for dining are commonly known and numerous utensil designs have been developed for specific dining applications. Utensil design can have a significant impact on the dining experience, and it is desirable to have utensils that are adapted for certain types of dining and certain diners. Further, parents and children are always searching for ways to make dining more enjoyable. Parents also value opportunities to provide children with an educational dining experience with easy-to-handle utensils that children are more likely to use. There exists a need for dining utensils that are interesting to children and that enable an innovative, interesting, and educational dining experience.

### SUMMARY OF THE INVENTION

According to one embodiment of the present invention, dining utensils are provided which utilize an animal theme to provide an interesting dining experience.

According to another embodiment of the present invention, a plurality of dining utensils are provided and packaged together, with packaged dining utensils including a variety of animal themes.

According to another embodiment of the present invention, dining utensils have functional components corresponding to animal features.

According to another embodiment of the present invention, forks having an animal theme are provided with fork tines corresponding to first animal features and fork handles corresponding to second animal features.

According to yet another embodiment of the present invention, spoons having an animal theme are provided with spoon bowls corresponding to first animal features and spoon handles corresponding to second animal features.

According to still another embodiment of the present invention, knives having an animal theme are provided with blades corresponding to first animal features and knife handles corresponding to second animal features.

According to still another embodiment of the present invention, spreaders having an animal theme are provided with spatulas corresponding to first animal features and spreader handles corresponding to second animal features.

The above summary of the present invention is not intended to represent each embodiment, or every aspect, of the present invention. Additional features and benefits of the present invention will become apparent from the detailed description, figures, and claims set forth below.

### BRIEF DESCRIPTION OF THE DRAWINGS

In the drawings:

FIG. 1a is a front view of a fork having an octopus depiction according to one embodiment of the present invention;

FIG. 1b is a cross-sectional side view taken along the line 1b-1b of FIG. 1a;

FIG. 2a is a front view of a fork having a giraffe depiction according to one embodiment of the present invention;

FIG. 2b is a cross-sectional side view taken along the line 2b-2b of FIG. 2a;

FIG. 3a is a front view of a fork having a flamingo depiction according to one embodiment of the present invention;

FIG. 3b is a cross-sectional side view taken along the line 3b-3b of FIG. 3a;

FIG. 4a is a front view of a fork having a deer depiction according to one embodiment of the present invention;

FIG. 4b is a cross-sectional side view taken along the line 4b-4b of FIG. 4a;

FIG. 5a is a front view of a fork having a frog depiction according to one embodiment of the present invention;

FIG. 5b is a cross-sectional side view taken along the line 5b-5b of FIG. 5a;

FIG. 6a is a front view of a fork having a lobster depiction according to one embodiment of the present invention;

FIG. 6b is a cross-sectional side view taken along the line 6b-6b of FIG. 6a;

FIG. 7a is a front view of a spoon having an elephant depiction according to one embodiment of the present invention;

FIG. 7b is a cross-sectional side view taken along the line 7b-7b of FIG. 7a;

FIG. 8a is a front view of a spoon having a whale depiction according to one embodiment of the present invention;

FIG. 8b is a cross-sectional side view taken along the line 8b-8b of FIG. 8a;

FIG. 9a is a front view of a spoon having a monkey depiction according to one embodiment of the present invention;

FIG. 9b is a cross-sectional side view taken along the line 9b-9b of FIG. 9a;

FIG. 10a is a front view of a spoon having a walrus depiction according to one embodiment of the present invention;

FIG. 10b is a cross-sectional side view taken along the line 10b-10b of FIG. 10a;

FIG. 11a is a front view of a spoon having a pelican depiction according to one embodiment of the present invention;

FIG. 11b is a cross-sectional side view taken along the line 11b-11b of FIG. 11a;

FIG. 12a is a front view of a spoon having a baby snake depiction according to one embodiment of the present invention;

FIG. 12b is a cross-sectional side view taken along the line 12b-12b of FIG. 12a;

FIG. 13 is a side view of a knife having an alligator depiction according to one embodiment of the present invention;

FIG. 14 is a side view of a knife having a caterpillar depiction according to one embodiment of the present invention;

FIG. 15 is a side view of a knife having a seahorse depiction according to one embodiment of the present invention;

FIG. 16a is a front view of a spreader having a bunny depiction according to one embodiment of the present invention; and

FIG. 16b is a cross-sectional side view taken along the line 19b-l9b of FIG. 19a.

FIG. 17a is a front view of a spreader having a beaver depiction according to one embodiment of the present invention;

FIG. 17b is a cross-sectional side view taken along the line 17b-17b of FIG. 17a;

FIG. 18a is a front view of a spreader having a puppy depiction according to one embodiment of the present invention; and

FIG. 18b is a cross-sectional side view taken along the line 18b-18b of FIG. 18a.

While the invention is susceptible to various modifications and alternative forms, specific embodiments will be shown by way of example in the drawings and will be described in detail herein. It should be understood, however, that the invention is not intended to be limited to the particular forms disclosed. Rather, the invention is to cover all modifications, equivalents and alternatives falling within the spirit and scope of the invention as defined by the appended claims.

### DETAILED DESCRIPTION OF THE ILLUSTRATED EMBODIMENTS

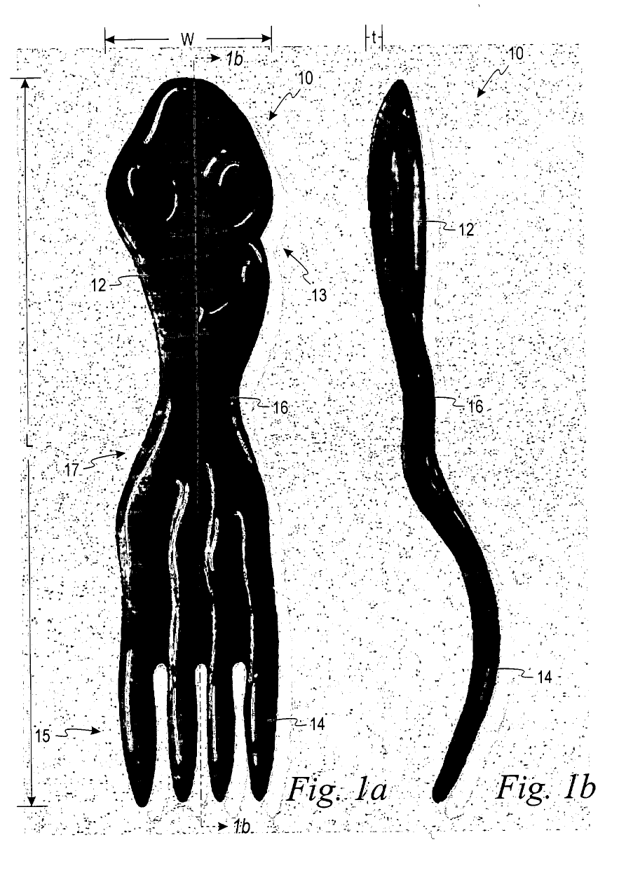

Utensils according to some embodiments of the present invention incorporate animal features into their elements, such that animal features become functional elements of the utensils. As described in this detailed description, certain combinations of animal features and utensil elements are particularly beneficial. First, second, third, or additional animal features may be incorporated and used as first, second, third, or additional utensil elements. For example, according to some embodiments of the present invention, animal heads are used as utensil handles while animal limbs are used as food-holding utensil portions. A utensil incorporating these features is shown in FIG. 1a, which shows a fork 10 having octopus features incorporated therein. A head feature 12 of the octopus serves as the handle 13 of the fork 10, and tentacle features 14 of the octopus serve as tines 15 of the fork 10. A body feature 16 of the octopus may serve as a contour grip of the fork 10. The contoured body portion of the octopus is further depicted in FIG. 1b, which shows a cross-sectional view of the fork 10. The front and side views of FIGS. 1a and 1b show that a contoured body and embossed features serve to make the utensil easier to grip and further serve to highlight the animal depiction on the utensil. In addition to corresponding with rounded portions of the animal features, the rounded features of the utensil serve to both enable easy gripping by children, increasing the educational aspect of the dining experience by facilitating utensil use. Ease of use is further enhanced by the use of an oblong portion on the handle 13 of the utensil. These features may be incorporated into all utensils according to the present invention.

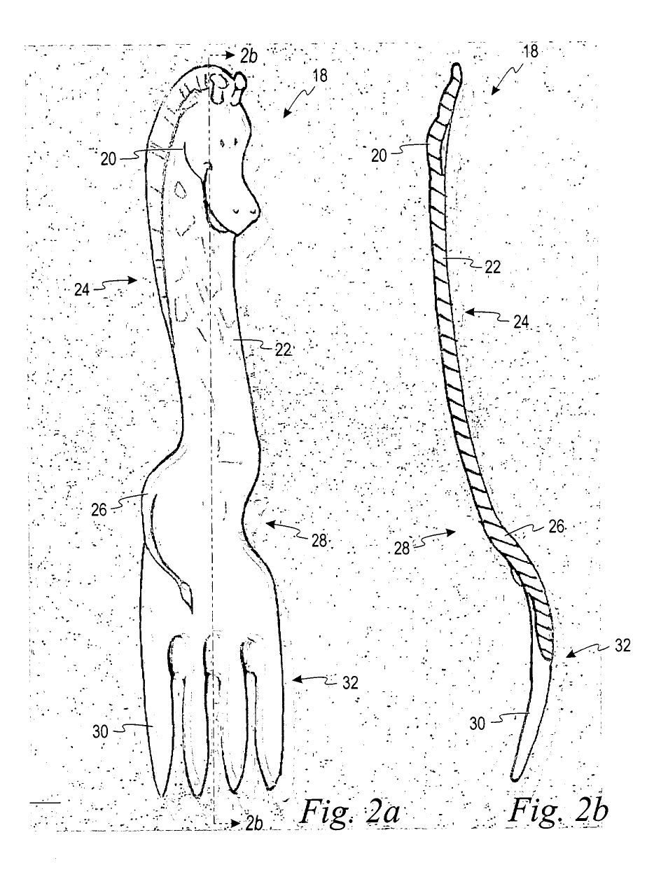

Several other combinations of animal features and utensil elements are used in other embodiments of the present invention. Though specific animal depictions are used to illustrate the ways in which animal features may be incorporated into utensil elements, it is to be understood that many alternative animals and animal feature combinations may be used in utensils according to the present invention. Turning now to FIG. 2a front view of a fork 18 having a giraffe depiction is shown. In the fork 18, a giraffe head feature 20 and a giraffe neck feature 22 combine to form a fork handle 24, a giraffe body feature 26 forms a fork contour grip 28, and giraffe leg features 30 form fork tines 32. As shown in FIG. 2b, a cross-sectional view of the fork 18, the fork 18 is given a generally curved cross-section to facilitate gripping and use of the fork.

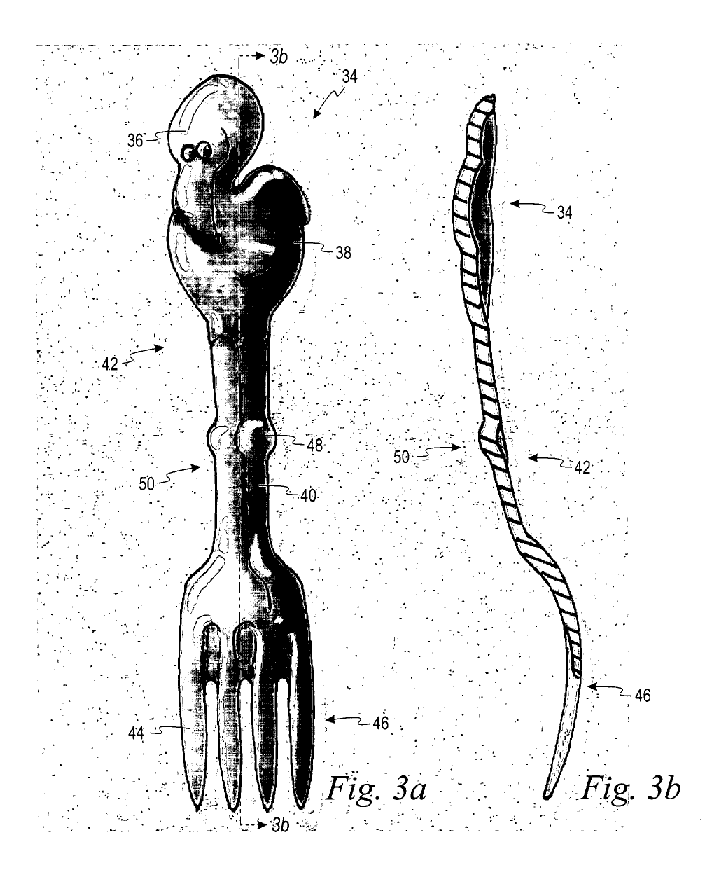

According to one embodiment of the present invention, an animal head, body, and legs are used as animal features to form a handle element of a fork, with animal feet being the animal features that form tines of a fork. FIG. 3a is a front view of a fork 34 having a flamingo depiction, with the head 36, body 38, and legs 40 of the flamingo forming a handle 42 of the fork and the feet 44 of the flamingo forming the tines 46 of the fork 34. Knees 48 of the flamingo form a contoured grip 50 of the fork 34.

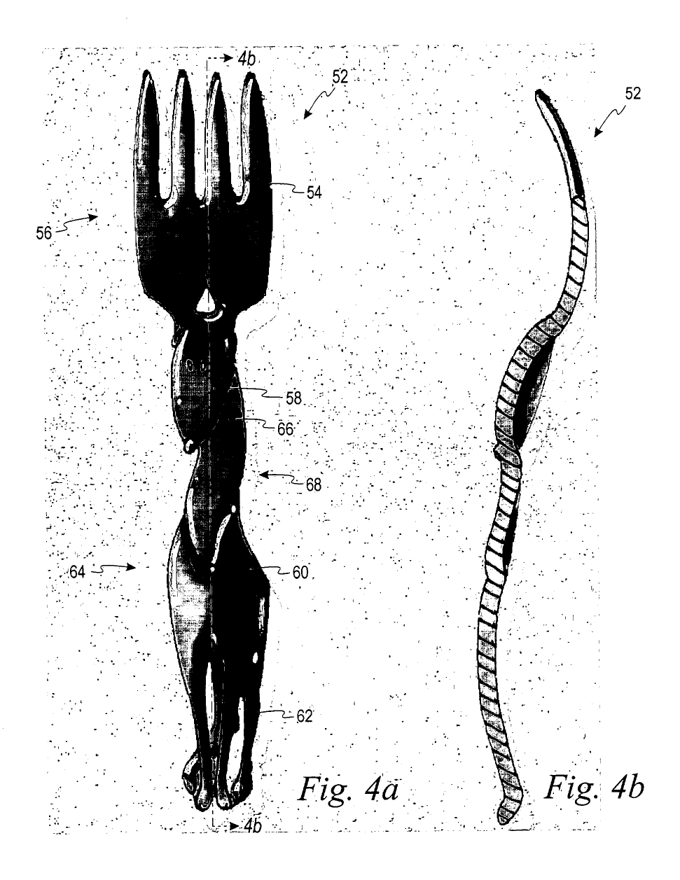

As will be understood in reference to the utensils described above, some animal depictions having particularly unique features may be incorporated into utensils in novel ways. For example, as shown in FIG. 4a, a fork 52 according to one embodiment of the present invention has a deer depiction, with antlers 54 of the deer serving as tines 56 of the fork 52. Head 58, body 60, and leg 62 features of the deer form a handle 64 of the fork 52, with a neck feature 66 of the deer depiction forming a contour grip portion 68 of the fork 52. The contour of the fork 52 is more clearly shown in FIG. 4b, which is a cross-sectional view of the fork 52.

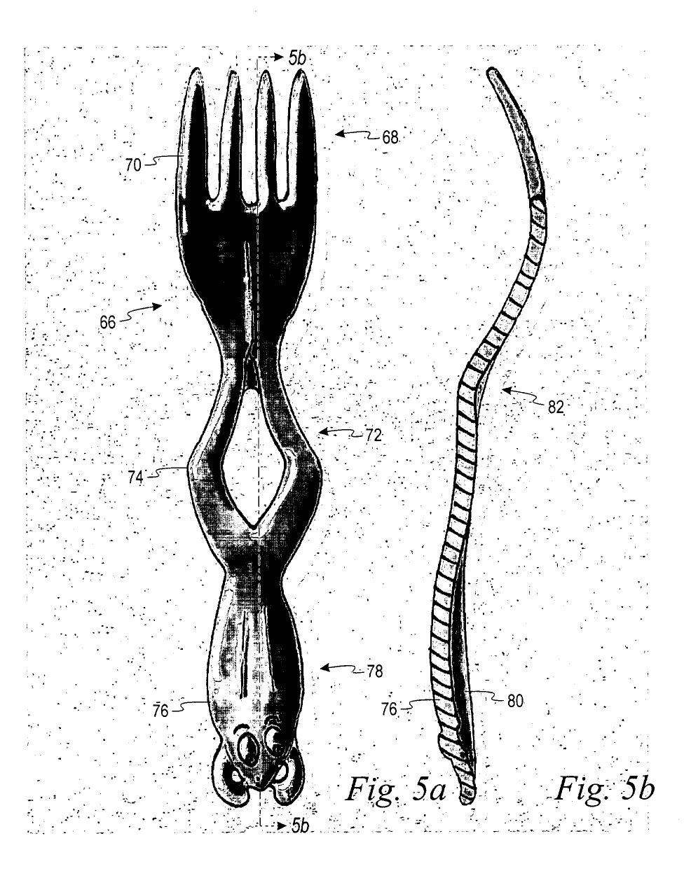

Turning now to FIG. 5a, a fork 66 is shown incorporating a depiction of a frog, further showing a way in which animal features may be incorporated into utensil elements according to the present invention. In the embodiment of FIG. 5a, tines 68 of a fork are comprised of feet features 70 of the frog, a contoured grip 72 of the fork is comprised of leg features 74 of the frog, and body and head features 76 of the frog depiction are used to form a handle 78 of the fork 68. FIG. 5b shows a cross-sectional view of the fork 68, showing a concave grip 80 beneath the body and head features 76 of the frog depiction and further showing a contoured grip feature which is integrated into the combined fork and frog depiction.

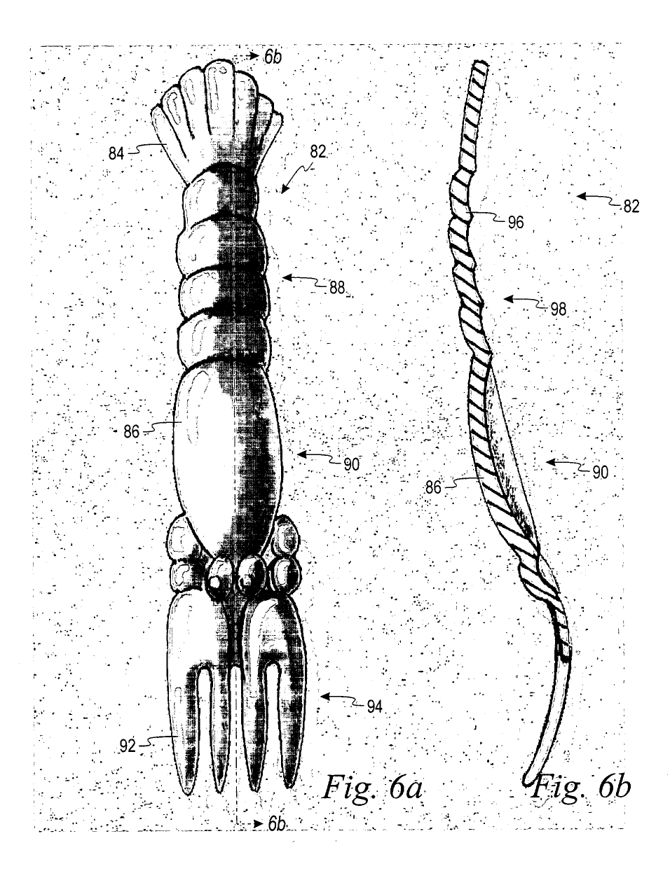

Yet another organization of animal features and utensil elements is shown in FIG. 6a, which is a front view of a fork 82 having a lobster depiction. In this depiction, a fin feature 84 of the lobster depiction and a body feature 86 of the lobster depiction combine to form a handle 88 and contoured grip 90 of the fork 82. Pincer features 92 of the lobster depiction form tines 94 of the fork. The contour of this embodiment is shown in FIG. 6b, which is a cross-sectional view of a fork with a lobster depiction, illustrating the concavity of the contoured grip 90 beneath the body feature 86 of the lobster depiction. Further, several tail segments 96 form a second grip portion 98 further enhancing the ease of use of the fork 82.

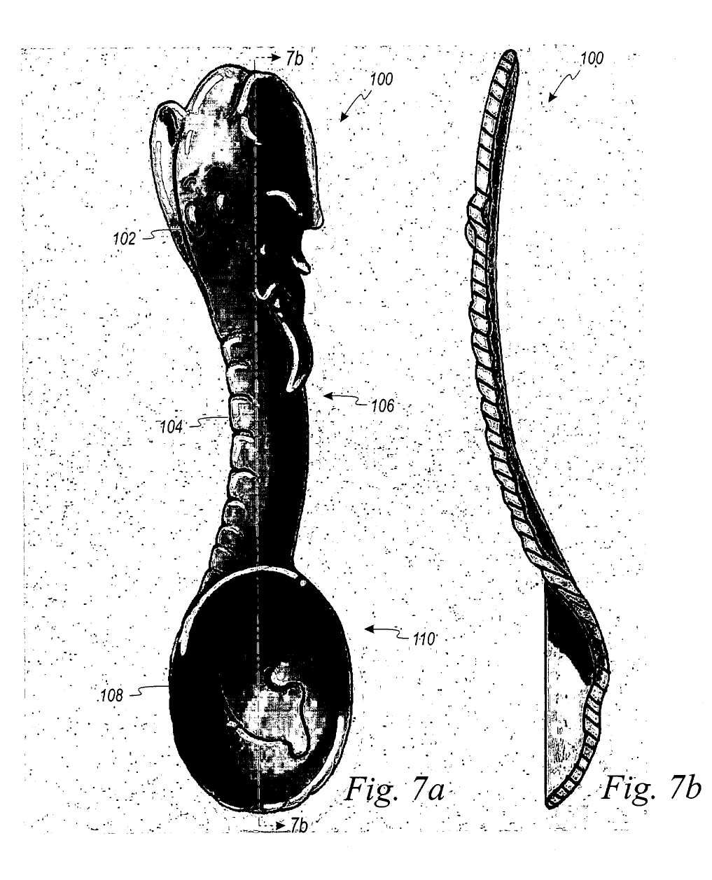

Conformations of animal features and utensil elements according to the present invention may be applied to several types of utensils. Turning now to FIG. 7a, a spoon 100 is shown incorporating an elephant depiction according to one embodiment of the present invention. A head feature 102 of the elephant depiction combines with an upper trunk portion 104 of the elephant depiction to form a spoon handle 106, while a lower trunk portion 108 of the elephant depiction forms a spoon bowl 110. A portion of the trunk depiction is used to form a contoured grip on the handle 106 of the spoon 100. FIG. 7b shows a cross-sectional view of the spoon 100, more clearly showing the contoured shape of the handle 106.

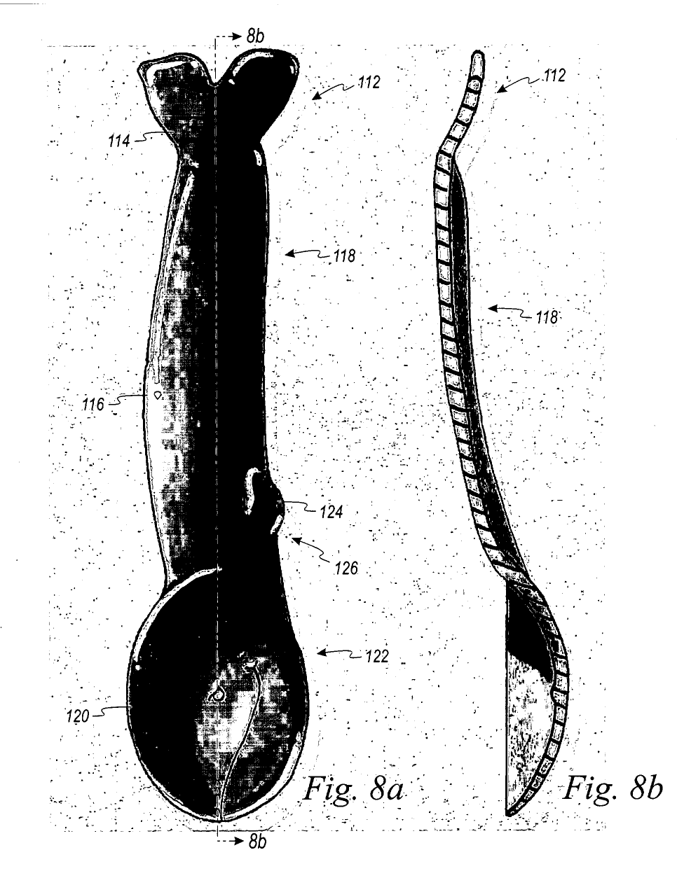

Similarly to the fork embodiments discussed above, embodiments of the present invention incorporating animal features into spoon elements may take a variety of forms. Turning now to FIG. 8a, an alternative spoon embodiment is shown in which a spoon 112 is provided with a whale depiction. The spoon 112 has a whale fin feature 114 and a whale body feature 116 that combine to make up a handle 118 of the spoon, while a whale head feature 120 makes up the spoon bowl 122. A whale flipper feature 124 forms a grip portion 126 of the spoon 112. FIG. 8b shows a cross-sectional side view of the spoon 112, showing the contour of the handle portion 118. The handle portion 118 includes a concave formation when looked at from below, both highlighting the curved features of the whale depiction and further facilitating the gripping and handling of the spoon 112.

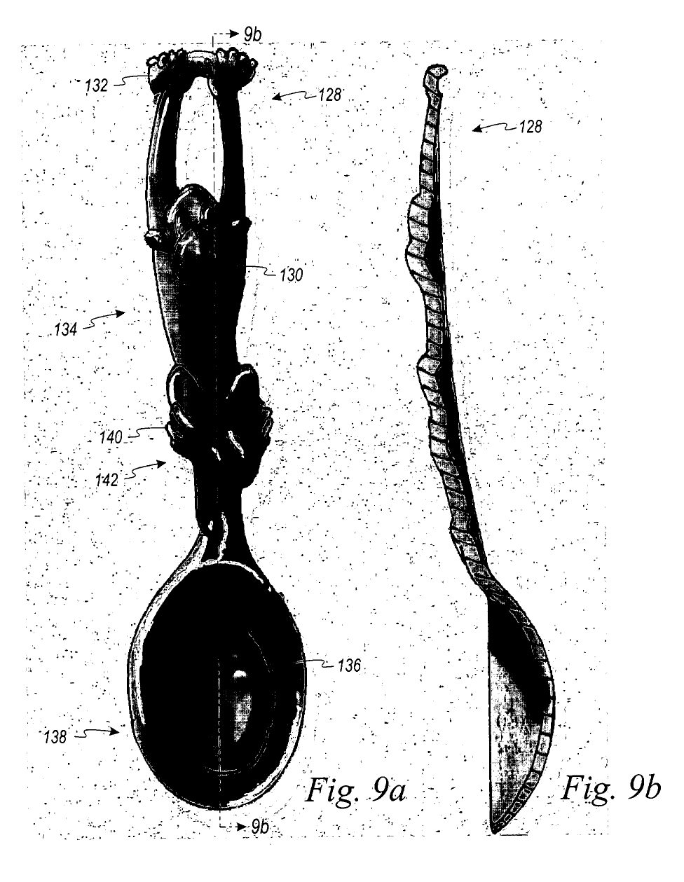

Turning now to FIG. 9a, an alternative embodiment of a spoon incorporating an animal depiction is shown. The spoon 128 of FIG. 9a incorporates the features of a monkey depiction into spoon elements. Depictions of a monkey body 130 and arms 132 serve as a handle 134 of the spoon 128, while a depiction of a monkey tail 136 forms the bowl 138 of the spoon. Depictions of monkey feet 140 are incorporated into the spoon design 128 and serve to provide a grip portion 142 of the spoon. FIG. 9b shows a cross-sectional side view of the spoon 128, showing how portions of the monkey depiction are contoured to provide an easy-to-grip spoon. The side-view of FIG. 9b further illustrates the embossing of the utensil, which both makes gripping easier and makes the depicted character more realistic.

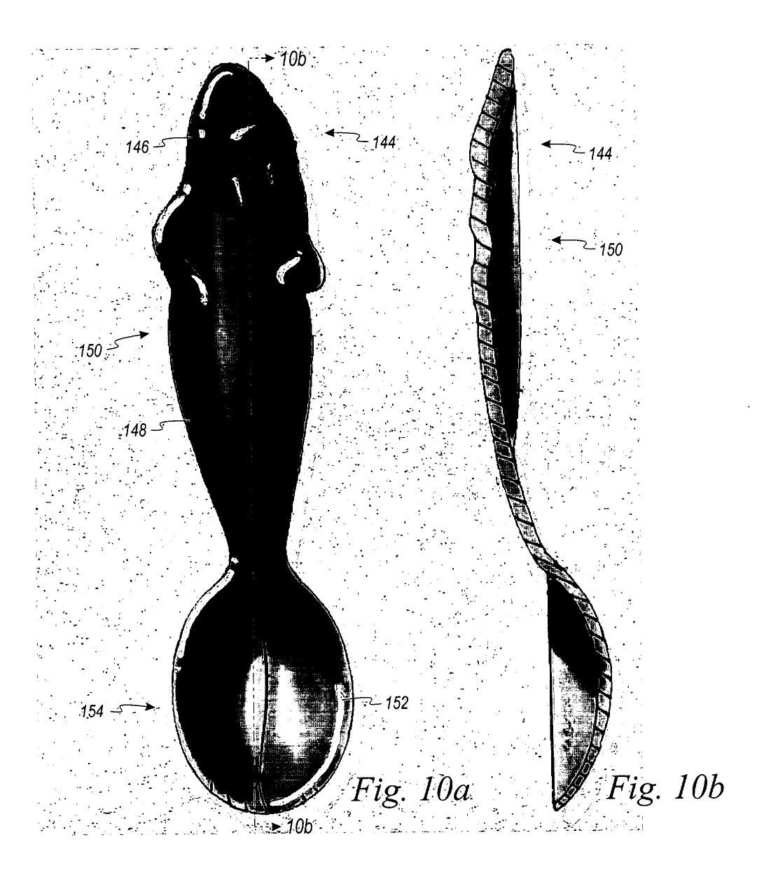

Turning now to FIG. 10a, an alternative embodiment of a spoon according to the present invention is shown incorporating a walrus depiction. The spoon 144 of FIG. 10a incorporates walrus head 146 and body 148 depictions into the spoon handle 150 and further incorporates walrus fin depictions 152 into the spoon bowl 154. Further, the handle 150 is contoured both to be more easily gripped and to enhance the curved features of the walrus depiction, as shown in the cross-sectional view of FIG. 10b.

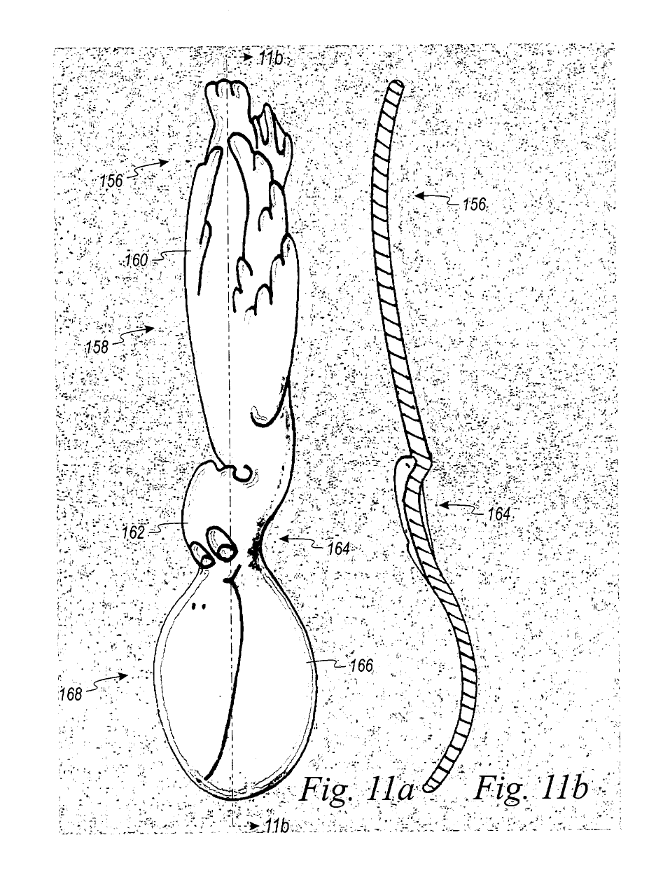

Turning now to FIG. 11a, yet another alternative embodiment of a spoon according to the present invention is shown. The spoon 156 of FIG. 11a incorporates features of a pelican depiction into spoon elements. The handle 158 of the spoon 156 incorporates a pelican body depiction 160, and a pelican head depiction 162 is used to form a contoured grip element 164 of the spoon 156. The bill 166 of the pelican depiction forms the bowl 168 of the spoon. The contoured shape of the spoon 156 and particularly of the contoured grip element 164 is more clearly shown in the cross-sectional side view of FIG. 11b.

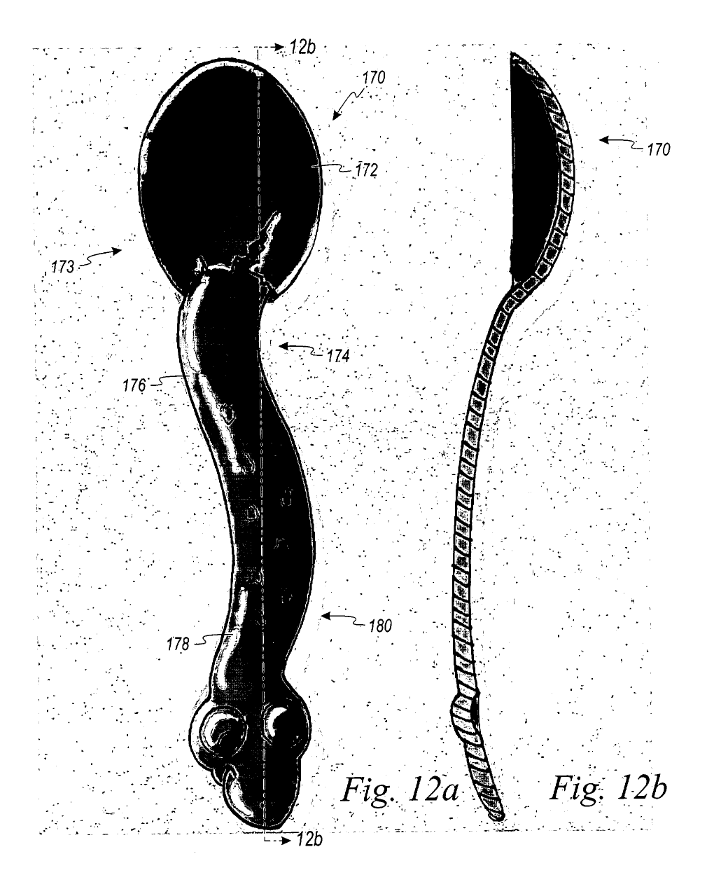

Turning now to FIG. 12a, another alternative embodiment of a spoon according to the present invention is shown. The spoon 170 of FIG. 12 a incorporates a depiction of a baby snake emerging from an egg. The egg depiction 172 forms the bowl 173 of the spoon 170, while head and body depictions 178 form a handle 180 of the spoon 170. A contoured grip portion 174 is formed from a depiction of a bend 176 in the snake depiction. The snake depiction is contoured to enable easy gripping and use of the spoon 170, as shown in the cross-sectional side view of FIG. 12b.

Another utensil which may incorporate features of an animal depiction according to some embodiments of the present invention is the knife. FIG. 13 is a side view of a knife 182 incorporating an alligator depiction according to one embodiment of the present invention. The knife handle 184 is formed of an alligator body depiction 186, and an alligator head depiction 188 is used to form a grip element 190. An alligator snout depiction 192 is used to form the blade 194 of the knife 182. The blade, in turn, uses depictions of alligator teeth 196 to form serrated blade members 198.

A knife 199 according to another embodiment of the present invention and incorporating a caterpillar depiction is shown in FIG. 14. A caterpillar head depiction 200 and body depiction 202 form a handle 204 of the knife 199, a bend 206 in the caterpillar body depiction forms a grip portion 208 of the knife, and a back portion 210 of the body depiction forms the blade 212 of the knife. Caterpillar feet depictions 214 are used to form serrated portions 216 of the knife blade 212, and segmented body portions 218 of the caterpillar depiction form finger grips 220 of the handle 204.

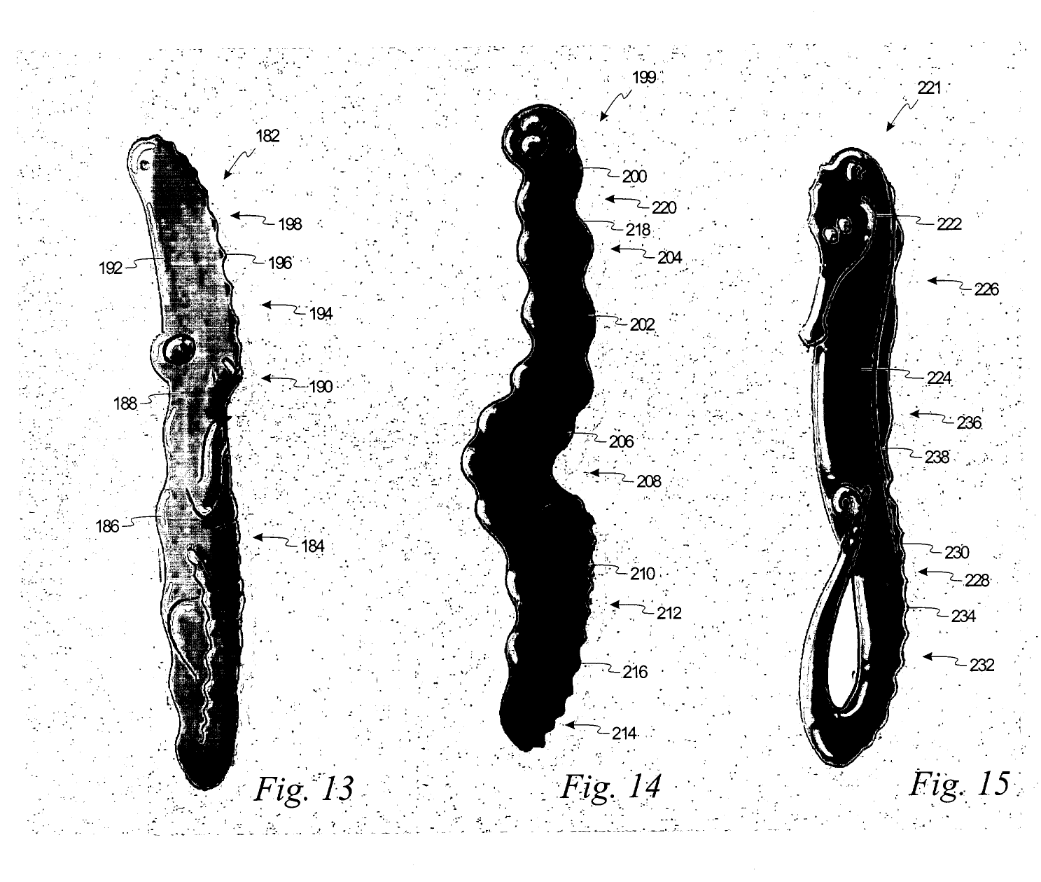

Another embodiment of a knife according to the present invention is shown in FIG. 15. The knife 221 of FIG. 15 is constructed using a seahorse depiction, with a seahorse head depiction 222 and a seahorse body depiction 224 forming a handle portion 226 of the knife 221. The knife blade 228 is formed of a seahorse tail depiction 230, with serrated portions 232 of the blade being formed of seahorse scale depictions 234. Grip portions 236 of the handle 226 are integrated with seahorse ridge depictions 238.

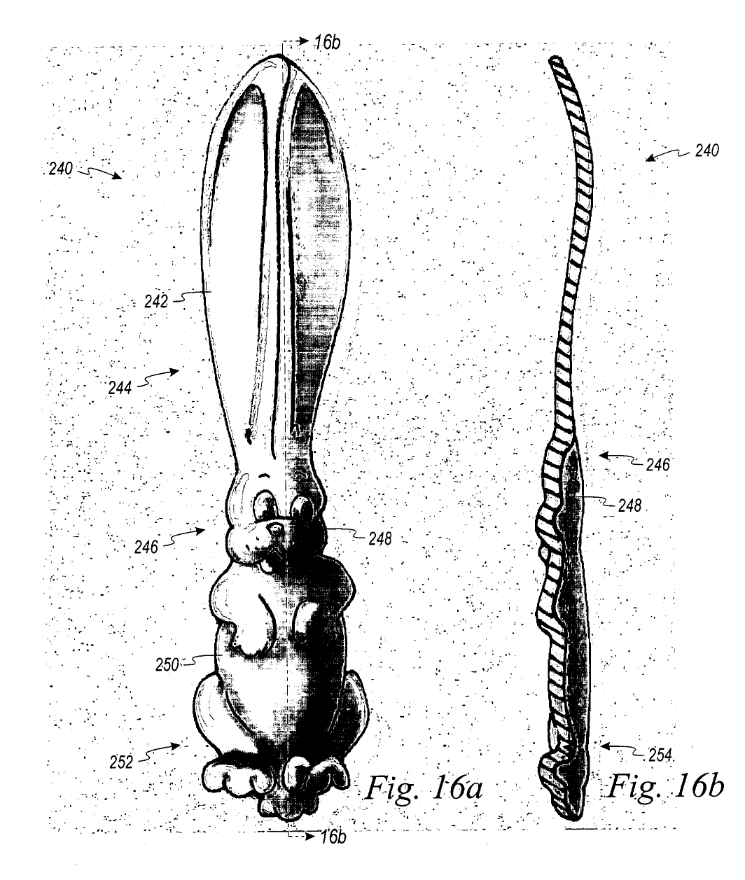

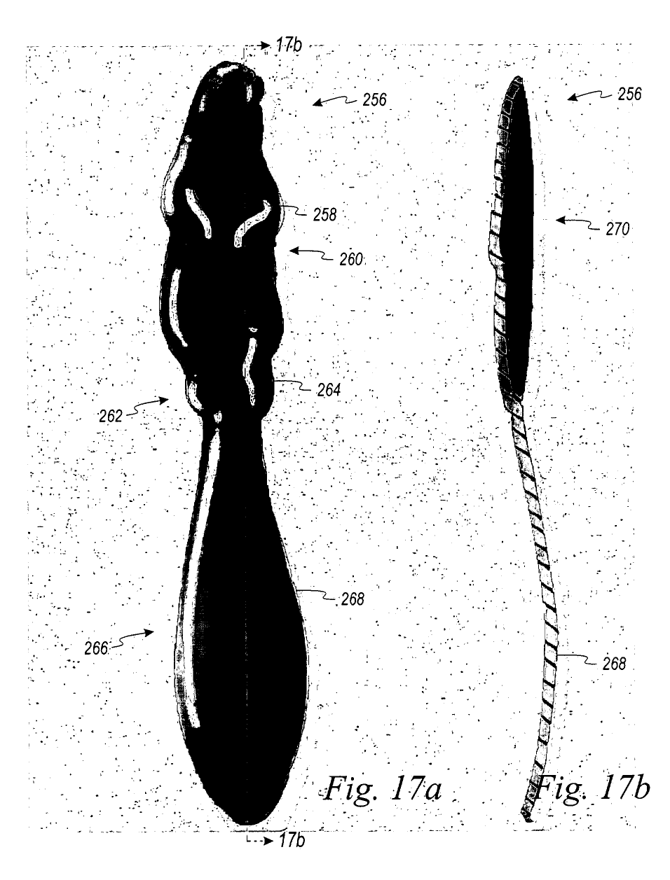

Another utensil which may incorporate animal depictions according to the present invention is a spreader—a spatula which is used to spread ingredients such as butter, peanut butter, or jelly. Turning now to FIG. 16a, a spreader 240 incorporating a depiction of a bunny is shown. Depictions of bunny ears 242 are used to form the spatula 244 of the spreader 240, a grip portion 246 of the spreader 240 is formed using a depiction of a bunny head 248, and a body portion 250 of the bunny depiction forms a handle 252 of the spreader. FIG. 16b shows a cutaway side view of the spreader 240, showing the contour of the spatula portion 242 as well as the concave shape (when viewed from below) of the handle 252 and bunny body depiction 250, which serves to facilitate gripping and use of the spreader 240.

Similarly to the other utensil embodiments described herein, spreaders according to the present invention may incorporate a variety of animal feature depictions as a variety of utensil elements. FIG. 17a shows a spreader 256 using a depiction of a beaver. A beaver body depiction 258 serves to form a handle portion 260 of the spreader, with a grip portion 262 being formed using a depiction 264 of beaver feet. The spatula portion 266 of the spreader 256 is formed using a depiction of a beaver tail 268. The cutaway side view of FIG. 17b shows a concave formation 270 (when viewed from below) of the handle 260, which serves to facilitate use of the spreader 256, and further shows the contour of the spatula portion 268.

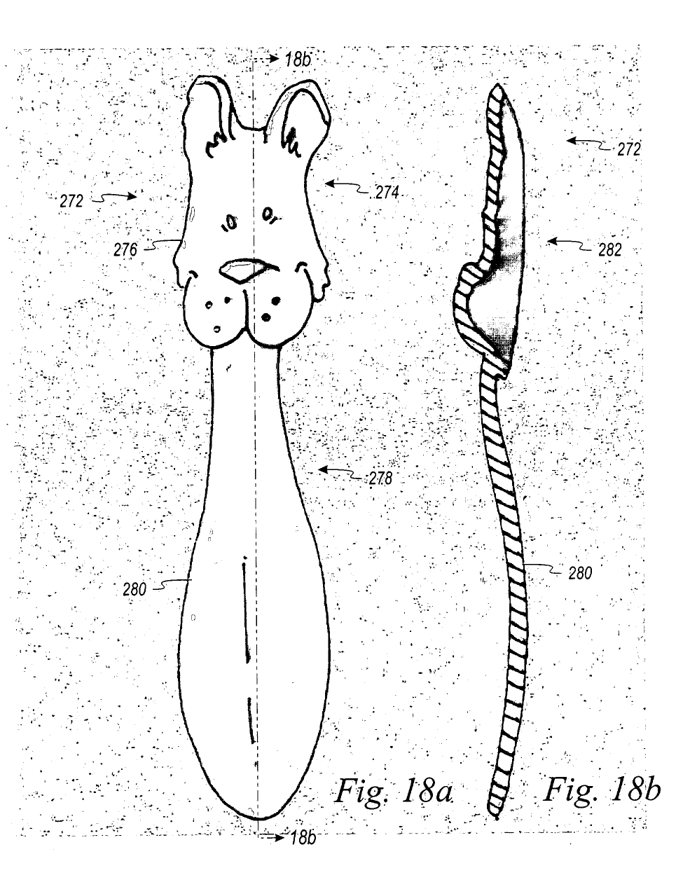

Another spreader embodiment according to the present invention is shown in FIG. 18a. The spreader 272 of FIG. 18a uses features of a puppy depiction to form spreader elements. A handle 274 of the spreader 272 is formed of a puppy head depiction 276, and a spatula portion 278 of the spreader 272 is formed of a puppy tongue depiction 280. FIG. 18b shows a side cutaway view of the spreader 272, showing a concave portion 282 (when viewed from below) that serves to highlight the depiction of the puppy head 276 and also enables easier gripping an use of the spreader 272.

Utensils according to the present invention may be made of a variety of materials and may be made in a variety of sizes. For example, according to some embodiments of the present invention, utensils are primarily designed as disposable utensils and are constructed of plastic. Plastics from which utensils according to some embodiments of the present invention may be made include plastics such as polypropylene and polystyrene, metals, and combinations of materials. For example, utensils according to the present invention may be provided with food-contacting portions made of metal and handles made of plastic. Further, it is preferable for utensils according to some embodiments of the present invention to be particularly sized for children to use. Many different sizes may be used, with utensil lengths l (shown in FIG. 1a) from approximately 120 mm to approximately 170 mm and utensil widths w (shown in FIG. 1a) ranging from approximately 15 mm to approximately 35 mm being used in some embodiments of the present invention. A handle width of approximately 25 mm is advantageous in some embodiments of the present invention for enabling easy handling of utensils by children. Further, utensils of many thicknesses t (shown in FIG. 1b) may be manufactured according to the present invention. For example, utensil thicknesses of from about 1.7 mm to about 5 mm being used in some embodiments of the present invention.

Utensils according to the present invention may be packaged and sold in a variety of assortments. It is preferable in some embodiments of the present invention to provided a variety of different types of forks, knives, spoons, and spreaders within a single package, with each of the utensils featuring different conformations of animal features used for different utensil elements. Utensils according to the present invention may be made in a variety of colors, and utensils having different animal features and different colors may be packaged and sold in the same container. In addition, alternative utensil designs such as spork (combined spoons and forks) and double-ended utensils (for example, having a fork on one end of the utensil and a spoon on the other end) may be implemented in alternative embodiments of the present invention.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A utensil incorporating depictions of animal features in an animal theme comprising:
a first utensil element depicting a first feature of an animal depiction corresponding to said animal theme; and
a second utensil element depicting a second feature of an animal depiction corresponding to said animal theme.

2. The utensil of claim 1 wherein said utensil is a fork, said first utensil element is a handle, and said second utensil element comprises tines of said fork.

3. The utensil of claim 1 wherein said utensil is a spoon, said first utensil element is a handle, and said second utensil element comprises a bowl of said spoon.

4. The utensil of claim 1 wherein said utensil is a knife, said first utensil element is a handle, and said second utensil element comprises a blade of said knife.

5. The utensil of claim 1 wherein said utensil is a spreader, said first utensil element is a handle, and said second utensil element comprises a spatula of said spreader.

6. A knife corresponding to an animal theme and containing an animal depiction, said knife comprising:
a handle portion corresponding to a depiction of a first animal feature;
a grip portion corresponding to a depiction of a second animal feature; and
a blade portion corresponding to a depiction of a third animal feature.

7. The knife of claim 6 wherein said animal theme is an alligator theme, said depiction of said first animal feature is a depiction of an alligator body feature, said depiction of said second animal feature is a depiction of an alligator head feature, and said depiction of said third animal feature is a depiction of an alligator snout feature.

8. The knife of claim 6 wherein said animal theme is a caterpillar theme, said depiction of said first animal feature is a depiction of a front caterpillar body feature, said depiction of said second animal feature is a depiction of a bend in said caterpillar body feature, and said depiction of said third animal feature is a depiction of a rear caterpillar body feature.

9. The knife of claim 6 wherein said animal theme is a seahorse theme, said depiction of said first animal feature is a depiction of a seahorse head feature, said depiction of said second animal feature is a depiction of a seahorse ridge feature, and said depiction of said third animal feature is a depiction of a seahorse tail feature.

10. A method of manufacturing and packaging utensils comprising:
manufacturing a first utensil having a first utensil element depicting a first feature of a first animal and a second utensil element depicting a second feature of said first animal;
manufacturing a second utensil having a first utensil element depicting a first feature of a second animal and a second utensil element depicting a second feature of said second animal; and
packaging said first utensil with said second utensil.

11. The method of claim 10 wherein said first utensil is a fork, said first utensil element comprising a fork handle and said second utensil element comprising fork tines.

12. The method of claim 11 wherein said first feature of said first animal comprises an animal feature selected from the group consisting of head features and body features and said second feature of said first animal comprises an animal feature selected from the group consisting of leg features, feet features, and pincer features.

13. The method of claim 10 wherein said second utensil is a spoon, said first utensil element comprising a spoon handle and said second utensil element comprising a spoon bowl.

14. The method of claim 13 wherein said first feature of said second animal comprises a body feature and said second feature of said second animal comprises a head feature.

15. The method of claim 13 wherein said first feature of said second animal comprises a head feature and said second feature of said second animal comprises a body feature.

16. A dining utensil comprising:
a contoured handle portion comprising an embossed depiction of a first animal feature, said contoured handle portion having a curved grip portion coinciding with a curved portion of said first animal feature; and
a food-contacting portion comprising a depiction of a second animal feature.

17. The dining utensil of claim 16 wherein said contoured handle portion further comprises an oblong end portion, said oblong end portion corresponding with a depiction of a third animal feature.

18. The dining utensil of claim 17 wherein said oblong end portion has a width between approximately 15 mm and approximately 35 mm.

19. The dining utensil of claim 18 wherein said oblong end portion has a width of approximately 25 mm.

20. The dining utensil of claim 17 wherein said curved grip portion of said utensil is disposed between said oblong end portion of said utensil and said food-contacting portion of said utensil.
